(19) United States
(12) Patent Application Publication
(10) Pub. No.: US 2008/0245290 A1
(43) Pub. Date: Oct. 9, 2008

(54) Bookmark Apparatus

(76) Inventor: Chunran Kang, Lubbock, TX (US)

Correspondence Address: Jay M. Schloff;Intellipex PLLC, Suite 245, 30200 Telegraph Road, Bingham Farms, MI, 48025, US

(21) Appl. No.: 12/061,902

(22) Filed: Apr. 3, 2008

Related U.S. Application Data
(60) Provisional application No. 60/910,491, filed on Apr. 6, 2007.

(51) Int. Cl. B42D 9/00

(52) U.S. Cl. 116/239

(57) ABSTRACT

Disclosed are a bookmark apparatus and a method for making the bookmark apparatus thereof. The bookmark apparatus includes at least one string configured to form at least one minor loop and a major loop. The major loop is engaged to the at least one minor loop and a plurality of longitudinally extending strips extends from the at least one minor loop. The major loop of the bookmark apparatus is capable of circumscribing at least a portion of a book and each of the plurality of longitudinally extending strips is capable of being engaged to a position between a front cover and a back cover of the book, to mark the position thereof in the book.

### CROSS-REFERENCE TO RELATED APPLICATIONS

The present invention claims priority under 35 United States Code, Section 119 on the U.S. Provisional Patent Application numbered 60/910,491 filed on Apr. 6, 2007, the disclosure of which is incorporated by reference.

### FIELD OF THE INVENTION

The present invention generally relates to bookmarking techniques, and more specifically, to a bookmark apparatus capable of marking a plurality of pages in a book.

### BACKGROUND OF THE INVENTION

It is customary for readers to mark pages or selected points of books or other written materials while reading the book or the other written materials. Traditionally, readers have a habit of marking pages of the books by folding a corner of the pages. Such a habit of folding the corner of the pages may lead to defacing the printed materials thereon and the appearance of the book.

Another existing way of marking pages is through use of a flat rigid strip of plastic, paperboard, or cardboard. Such strips are commonly known as bookmarks. A reader may insert such bookmark at a desired position in a book, and optionally, can orient the bookmark so that a portion of the bookmark protrudes outwardly and is visible to the reader after the covers of the book have been closed. This orientation allows the reader to access the marked positions, i.e., pages easily.

The use of the above traditional bookmarks has certain limitations. For instance, structure of traditional bookmarks is such that the reader can only mark one page of the book at a time. If the reader wishes to mark a subsequent page, he or she must remove a traditional bookmark from the marked page to put the traditional bookmark on the subsequent page. The first marked page is then lost, unless the reader wishes to insert an additional traditional bookmark. The use of a plurality of such bookmarks may place undue stress on and thus damage the binding of the book, may make pages of the book difficult to turn, and otherwise involves complication of a process for the reader in that he or she must rely on a number of distinct pieces to effectuate his or her desired marking.

Accordingly, there is a need for a bookmark apparatus for marking positions in books without damaging the printed materials in the books. Further, the bookmark apparatus should also be capable of marking a plurality of pages of the book at a time. Further, there exists a need for a method of making such a bookmark apparatus for marking a plurality of pages of printed materials.

### SUMMARY OF THE INVENTION

In view of the foregoing disadvantages inherent in the prior art, the general purpose of the present invention is to provide a bookmark apparatus configured to include all advantages of the prior art, and to overcome the drawbacks inherent therein.

Therefore, an object of the present invention is to provide a bookmark apparatus that allows a reader to mark a plurality of pages of a book.

Another object of the present invention is to provide a bookmark apparatus that does not require a reader to store the bookmark apparatus separately from a book while reading the book.

Yet another object of the present invention is to provide a method of making a bookmark apparatus for marking a plurality of pages of a book at a time.

To achieve the above objects of the present invention, in an aspect, the present invention provides a bookmark apparatus comprising at least one string configured to form at least one minor loop and a major loop. The major loop is engaged to the at least one minor loop. The bookmark apparatus also comprises a plurality of longitudinally extending strips extending from the at least one minor loop. The major loop is capable of circumscribing at least a portion of a book and each of the plurality of longitudinally extending strips is capable of being engaged to a position between a front cover and a back cover of the book, to mark the position thereof in the book.

Further, in another aspect, the present invention provides a method for making a bookmark apparatus. The method for making the bookmark apparatus comprises configuring at least one minor loop by at least one string and coupling a plurality of longitudinally extending strips to the at least one minor loop. The method further includes configuring a major loop by the at least one string. The major loop is engaged to the at least one minor loop. The present invention provides the major loop capable of circumscribing at least a portion of a book and each of the plurality of longitudinally extending strips is capable of being engaged to a position between a front cover and a back cover of the book, to mark the position.

These together with the other aspects of the present invention, along with the various feature of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A illustrates a perspective view of a bookmark apparatus, in accordance with an exemplary embodiment of the present invention;

FIG. 1B illustrates a perspective view of the bookmark apparatus attached to a book, in accordance with an exemplary embodiment of the present invention;

FIG. 2 illustrates a perspective view of the bookmark apparatus, in accordance with an another exemplary embodiment of the present invention; and

FIG. 3 illustrates a flow chart of a method for making a bookmark apparatus, in accordance with another exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The term “first”, “second” and the like, herein do not denote any order, elevation or importance, but rather are used to distinguish placement of one element over another, and the terms “a” and “an” herein do not denote a limitation of quantity, but rather denote the presence of at least one of the referenced item.

The term “book” includes any bunch of bounded or unbounded printed materials or any bunch of bounded or unbounded written material or combination thereof.

The present invention provides a bookmark apparatus for marking a plurality of pages of a book at a time by a reader, by the help of a plurality of strips. These strips may be engaged in various positions in the book to mark the positions thereof. The bookmark apparatus includes at least one string that is configured to form loops that may be attached with the book to secure the bookmark apparatus to the book. The bookmark apparatus may remain attached to the book, even when the book is being read by the reader and the bookmark apparatus is not in use.

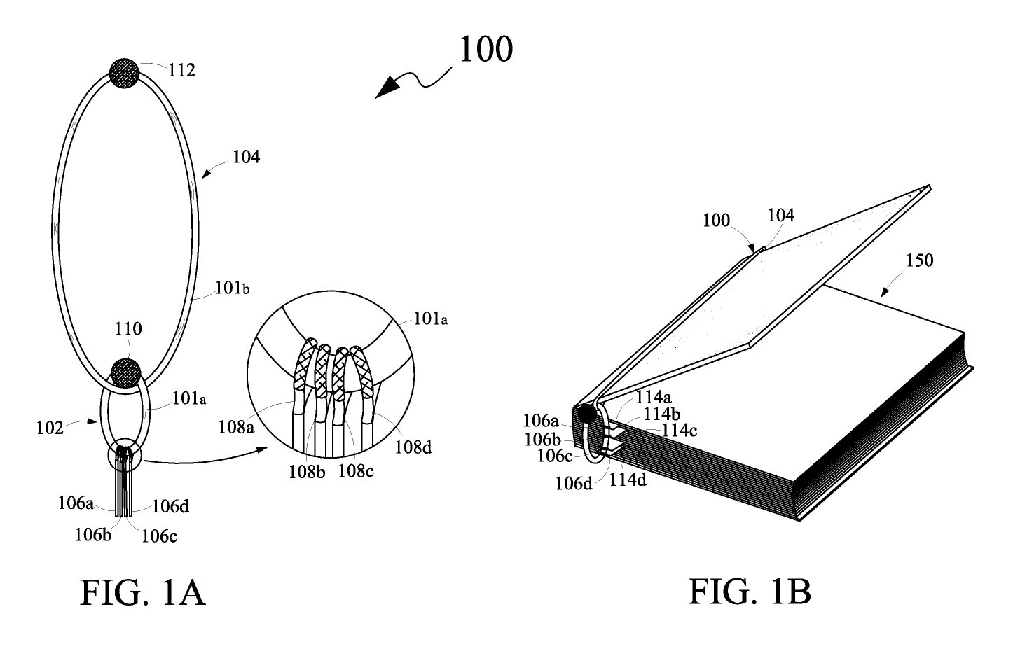

Referring to FIG. 1A, a perspective view of the bookmark apparatus 100 (herein after referred to as ‘bookmark 100’) in accordance with an exemplary embodiment of the present invention is illustrated. The bookmark 100 includes at least one string, such as a string 101ₐ and a string 101_{b} that are configured to form at least one minor loop such as a minor loop 102 and a major loop 104, and a plurality of longitudinally extending strips, such as strips 106a-d. The major loop 104 is engaged to the minor loop 102, and the strips 106a-d (hereinafter collectively referred to as ‘strips 106’) are coupled to the minor loop 102 to configure the bookmark 100 of an exemplary embodiment of the invention.

In an embodiment of the present invention, the string 101ₐ may have a length of 6 inches, and the string 101_{b} may have a length of 18 inches. The minor loop 102 is configured by attaching two opposite end portions of the string 101ₐ. In a preferred embodiment, the minor loop 102 may have a perimeter of 4 inches. Similarly, the major loop 104 is configured by attaching two opposite end portions of the string 101_{b}. In a preferred embodiment, the major loop 104 may have a varying perimeter, such as a perimeter of about 12 inches to a perimeter of about 20 inches that may be employed for the various sizes of the books. However, it will be apparent to those ordinary skilled in the art that the perimeter of the major loop 104 may be varied by accordingly varying the length of the string 101_{b}.

More specifically, the two opposite end portions of the string 101ₐ and the two opposite end portions of the string 101_{b} are attached by a knot to configure the minor loop 102 and the major loop 104, respectively. Alternatively, the two opposite end portions of each of the string 101ₐ and the string 101_{b} may be attached by a clasp, a ring, a bead, a braid, or any other conventional means to configure the minor loop 102 and the major loop 104, respectively.

In one embodiment, the strings 101ₐ and 101_{b} may be a stretchable string. The string 101_{b} may have a substantially uniform circular cross sectional dimension with a diameter of approximately varying between about 1.5 mm to about 2 mm. In another embodiment, the stretchable string may feature substantially uniform broad width or flat cross sectional dimension. In another embodiment, the strings 101ₐ and 101_{b} may be a non-stretchable string depending upon the requirement of the reader that may features circular or flat cross sectional dimensions. In further embodiment, out of the strings 101ₐ and 101_{b}, one string may be the stretchable string and another may be a non-stretchable string.

The major loop 104 is slidably engaged to the minor loop 102, the perspective view of which is shown in FIG. 1A. As described above, the minor loop 102 is configured by attaching the two opposite end portions of the string 101a. Once the minor loop 102 is configured by attaching the two opposite end portions of the string 101a, one of the two opposite end portions of the string 101_{b} is allowed to pass through the minor loop 102. The opposite end portions of the string 101_{b} are then attached, as described above, to configure the major loop 104 that has the minor loop 102 engaged therein. More specifically, the minor loop 102 is engaged with the major loop 104, in such a manner that the minor loop 102 remains free to rotate around the entire perimeter of the major loop 104. The movement of the minor loop 102 around the entire perimeter of the major loop 104 facilitates a reader to position the minor loop 102 at the top or bottom of the book to which the bookmark 100 is attached.

The strips 106 are coupled to the minor loop 102 by a plurality of crimped end clasps, such as a crimped end clasps 108a-108d. However, it will be obvious to a person skilled in the art that the strips 106 may be coupled by other means, such as clamps, rings and braids to the minor loop 102. Further, the number of strips in the strips 106 described hereinabove may not be considered to be limited only to four, as it is disclosed only for the purpose of the explanation of an exemplary embodiment of the invention.

Further, to obtain a firm and decorative bookmark, such as the bookmark 100, the minor loop 102 includes a first bead 110, and the major loop 104 includes a second bead 112. The attached opposite end portions of the minor loop 102 and the major loop 104 may be glued and then covered by the first bead 110 and the second bead 112, respectively. The glue may be a superglue that may be applied to secure the attached opposite end portions of the minor loop 102 and the major loop 104. The first bead 110 of the minor loop 102 is pulled over the glued and attached opposite end portions of the minor loop 102 for providing covering thereupon. Similarly, the second bead 112 of the major loop 104 is pulled over the glued and attached opposite end portions of the major loop 104 providing covering thereupon. Covering the attached and the glued opposite end portions of the minor loop 102 and the major loop 104 may provide the bookmark 100, which is firm and decorative.

Now referring to FIG. 1B, wherein a perspective view of a bookmark, such as the bookmark 100 attached to the book, such as a book 150 is shown. The bookmark 100 is attached to the book 150 by a major loop 104. More specifically, the major loop 104 of the bookmark 100 circumscribes at least a portion of the book 150. For example, the major loop 104 may circumscribe a front cover of the book 150 as shown in FIG. 1B. However, the major loop 104 may also be designed in such a manner that the major loop 104 may circumscribe any portion of the book 150 such as across pages between the front cover and a back cover of the book 150, or may circumscribe the front cover or the back cover of the book 150 and some pages between the front cover and the back cover of the book 150. Therefore, the major loop 104 of the bookmark 100 is attached to the book 150 and that does not require the reader to put the bookmark 100 separately from the book 150 while the reader is reading the book 150 and the bookmark 100 is not in use. Further, once the bookmark 100 is attached to the book 150, the strips 106 of the bookmark 100 may be used to mark various positions in the book 150.

Each strip of the strips 106 may be engaged to a position in the book 150, to mark the position such as positions 114a-d. For example, the strip 106a may be engaged at a position 114a to mark the position 114a, which is between two particular pages of the book 150. Similarly, the strips 106b-d may be engaged at positions 114b-d in the book 150. In one embodiment, the strips 106 may be made of suede fabric strips of approximately four inches in length to mark a position by engaging at the position, which may be between any two pages in the book 150. In another embodiment, strips 106 may be of variable colors to mark different pages of the book 150 where each strip may be used for different purpose by the reader of the book 150. In further embodiment, the strips 106 may be rewritable that may facilitate the reader to record simple numbers or words. This marking feature obviates the need, which otherwise arises in the case of traditional bookmarks, to move the traditional bookmarks off from one marked page to another marked page when the user wishes to mark a new page or a second, additional, or a subsequent page after the reader has marked a first page.

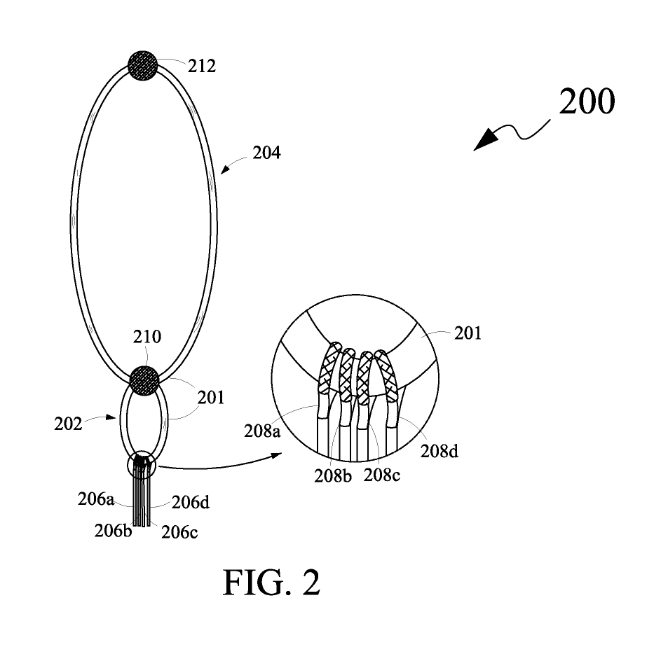

Referring now to FIG. 2A, a perspective view of a bookmark apparatus, such as a bookmark apparatus 200 (hereinafter referred to as ‘bookmark 200’) according to another exemplary embodiment of the present invention is illustrated. In accordance with this embodiment the bookmark 200 includes a string 201 that is configured to form a minor loop 202 and a major loop 204, and a plurality of longitudinally extending strips 206a-d (hereinafter collectively referred to as ‘strips 206’). The minor loop 202 is fixedly engaged to the major loop 204. The string 201, which is similar to the string 101ₐ or 101_{b}, has a length sufficient to configure the minor loop 202 and the major loop 204. In one embodiment, a suitable length of the string 201 may be of about 23 inches such that a length of 4 inches may be utilized to configure the minor loop 202 and a length of 16 inches may be utilized to configure the major loop 204, and the remaining length for knotting the minor loop 202 and the major loop 204.

Similar to the strips 106 as described in conjunction with FIG. 1B, the strips 206 are coupled to the minor loop 202 by crimped end clasps 208a-d, which are similar to the crimped end clasps 108a-108d. The strips 206 are slidably coupled to the minor loop 202 of the string 201 through the crimped end clasps 208a-d. Alternatively, the strips 206 may be slidably engaged to the minor loop 202 by any conventional method known in the art. Further, a first bead 210 similar to the first bead 110 is coupled to the string 201. The minor loop 202 is formed by tying a knot in the middle of the string 201, leaving behind two long leftover portions of the string 201 with two unattached end portions.

The first bead 210 may be glued at the position of the knot of the minor loop 202 to secure the knot. In an embodiment of the present invention, an end portion of one of the two long leftover portions of the string 201 is allowed to pass through the first bead 210. The first bead 210 is then pulled to bring the glued knot inside the first bead 210. Further, a second bead 212 is coupled to any one of the two long leftover portions of the string 201. The two unattached end portions of the string 201 are attached by a knot to form the major loop 204. The two unattached end portions of the string 201 may also be attached by other conventional means such as a clasp, a ring, a bead and a braid. Further, the knot of the major loop 204 may be glued and covered by the second bead 212 by pulling the second bead 212 over the glued knot to obtain the bookmark 200, which is firm and decorative. Herein, it will be apparent to those ordinary skilled in the art that the minor loop 202 is engaged with the major loop 204, in such a manner that the minor loop 202 remains fixed at one point on the major loop 204.

In another embodiment of the present invention, the bookmark 200 may include two or more minor loops similar to the minor loop 202 fixedly engaged to the major loop 204 to form a bookmark having two minor loops. The bookmark of this embodiment is capable of marking more numbers of pages of the book. It will be apparent to those skilled in the art that the bookmarks 100 and 200, being firm and decorative bookmarks, may also be used as a neckpiece for a casual wear, when the bookmarks 100 and 200 are not being used for the marking purposes in the book.

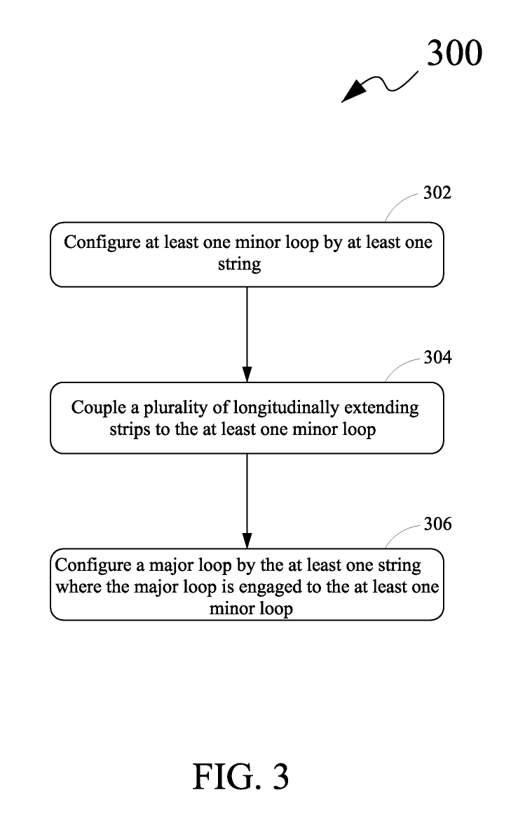

Without departing from the scope, the present invention discloses a quick and efficient method for making a bookmark, such as the bookmark 100 and the bookmark 200. The method is explained in detail in conjunction with FIG. 3. FIG. 3 illustrates a flow chart depicting a method 300 for making the bookmark, according to an exemplary embodiment of the present invention. The method for making a bookmark such as the bookmarks 100 and 200 starts at 302.

At 302, according to an embodiment of the present invention, at least one minor loop, such as the minor loop 102 is configured by a string of at least one string. Further at 304, the method includes coupling a plurality of the longitudinally extending strips similar to the strips 106 to the minor loop 102. Further, at 306, a major loop, such as the major loop 104 is configured by a string of the at least one string. Herein, the major loop is capable of circumscribing at least a portion of a book. Further each of the plurality of longitudinally extending strips is capable of being engaged to a position between the front cover and the back cover of the book, to mark the position thereof in the book.

More specifically, in one embodiment, at 302 the minor loop is configured by attaching two opposite end portions of a first string, such as the string 101ₐ as described in conjunction with FIG. 1A. After obtaining the minor loop by attaching the two opposite end portions of the first string, the two attached opposite end portions may be glued. The glued and attached opposite end portions may be covered by a first bead similar to the first bead 110. The first bead of the minor loop is pulled over to cover the glued and attached opposite end portions of the first string.

Furthermore, in accordance with this embodiment, at 306, a second string, such as the string 101_{b} having two opposite end portions, is engaged to the minor loop, and the two opposite end portions are attached to configure the major loop. The attached opposite end portions of the major loop may be glued. The major loop may include a second bead similar to the second bead 112 to cover the glued and attached opposite end portions of the major loop by pulling the second bead over the glued and attached opposite end portions of the major loop. The engagement between the major loop and the minor loop of this embodiment is a slidable engagement. The minor loop in the slidable engagement remains free to rotate around the entire perimeter of the major loop. The movement of the minor loop along the entire perimeter of the major loop facilitates a reader to position the minor loop at the top or the bottom of the book to which the bookmark 100 is attached.

Further, according to another exemplary embodiment, at 302, a minor loop such as the minor loop 202 is configured by knotting a string, such as the string 201 leaving behind two leftover portions of the string similar to the leftover portions of the string 201 described in conjunction with FIG. 2. Further at 304, the plurality of the longitudinally extending strips is coupled to the minor loop. Furthermore, at 306, a major loop, such as the major loop 204 is configured by attaching two opposite end portions of the two leftover portions of the string. In an embodiment of the present invention, prior to the 306, the knotted portion of the string may be glued. One of the two leftover portions of the string is allowed to pass through a first bead similar to the first bead 210. The first bead is then pulled to bring the glued knot inside the first bead. Further, a second bead similar to the second bead 212 may be used to cover a knot of the major loop, i.e., the attached portion of the two leftover portions of the string. It will be apparent to those ordinary skilled in the art that the opposite end portions of the two leftover portions of the string may also be attached by means of a knot, a clasp, a ring, a bead and a braid to form the major loop. Further, the knot is glued and covered by the second bead, by pulling the second bead over the glued knot

In another embodiment, a bookmark 100 includes at least one string, such as a string (not shown), that is configured to form a loop, and a plurality of longitudinally extending strips. The loop may attach to a book, and the strips may be used to mark a plurality of positions in a book, as described above.

Various embodiments of the present invention provide the following advantages. A bookmark apparatus, such as bookmarks 100 and 200 of the present invention allow a reader to mark a plurality of pages of books at any one time. Further, the bookmark apparatus is not required to be stored separately from a book by the reader, when the reader is reading the book and the bookmark apparatus is not in use. Furthermore, the method for making the bookmark apparatus of the present invention is simple, quick and efficient.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A bookmark apparatus, comprising:
at least one string configured to form at least one minor loop and a major loop, the major loop engaged to the at least one minor loop; and
a plurality of longitudinally extending strips extending from the at least one minor loop,
wherein the major loop is capable of circumscribing at least a portion of a book and each of the plurality of longitudinally extending strips is capable of being engaged to a position between a front cover and a back cover of the book, to mark the position.

2. The bookmark apparatus of claim 1, wherein the at least one minor loop is fixedly engaged to the major loop.

3. The bookmark apparatus of claim 1, wherein the at least one minor loop is slidably engaged to the major loop.

4. The bookmark apparatus of claim 1, wherein the at least one string is a stretchable string.

5. A method of making a bookmark apparatus, the method comprising:
configuring at least one minor loop by at least one string;
coupling a plurality of longitudinally extending strips to the at least one minor loop;
configuring a major loop by the at least one string, the major loop engaged to the at least one minor loop,
wherein the major loop is capable of circumscribing at least a portion of a book and each of the plurality of longitudinally extending strips is capable of being engaged to a position between a front cover and a back cover of the book, to mark the position.

6. The method of claim 5, wherein configuring the major loop by the at least string comprises fixedly engaging the major loop to the at least one minor loop.

7. The method of claim 5, wherein configuring the major loop by the at least string comprises slidably engaging the major loop to the at least one minor loop.

8. The method of claim 5, wherein the at least one string is a stretchable string.
